(19) United States
(12) Patent Application Publication
(10) Pub. No.: US 2004/0266294 A1
(43) Pub. Date: Dec. 30, 2004

(54) Reinforced flame-retardant and smoke-suppressive fabrics

(76) Inventor: John B. Rowen, Southborough, MA (US)

Correspondence Address: Mr. John B. Herring, Avtec Industries, 9 Kane Industrial Drive, Hudson, MA, 01749-2905, US

(21) Appl. No.: 10/609,239

(22) Filed: Jun. 27, 2003

(51) Int. Cl. B32B 27/12

(52) U.S. Cl. 442/149; 442/59

(57) ABSTRACT

The invention provides a flame-retarding and smoke-suppressing fabric including a cloth fabric 33.0 to 1400.0 grams per square meter, an adhesive binder 12.0 to 1050.0 grams per square meter of the cloth fabric, and an additive powder 120.0 to 6250.0 grams per square meter of the cloth fabric, the additive powder further including, by weight, a phosphate-based catalyst 30.0 to 41.0%, a carbonific 22.0 to 29.0%, a blowing agent 15.5 to 17.5%, a cementitious inorganic binder 21.0 to 25.0, and a ceramic 2.50 to 5.00.

### FIELD OF THE INVENTION

This invention relates generally to reinforced fabrics, and more particularly to flame-retardant and smoke-suppressive, re-enforcement, cloth fabrics.

### BACKGROUND OF THE INVENTION

Typically, resins are petroleum by-products that have potentially very harmful burning characteristics, i.e., high flammability at relatively low temperatures, very toxic and acrid smoke, and rapid destructive flame spread. It is well known that the flammability of thermoset and thermoplastic resins can be reduced by incorporating flame-retardant agents. However, when additives are combined with these resins, a multitude of problems can arise.

Synthetic polymer resins are frequently used in the manufacture of reinforced plastics, fiberglass laminates, and molded plastics. Due to their corrosive resistance, composite polymer materials are widely used in such industrial applications as structural components, siding and roof panels, roof decking, cable trays and mechanical parts such as threaded rod and strut due to their corrosion resistance. Plastics are also widely used by automobile, rail transportation and aircraft manufacturers because of their light weight and high strength.

The burning behavior of such materials, particularly those that are to be used in enclosed environments are of primary concern to the present invention. Many reinforced plastics can be designed to have a degree of fire resistance. Many fire-retardant additives are available. Unfortunately, a large number of the prior-art fire-retardant compounds give off extremely toxic fumes, such as nitrous oxides, cyanide compounds, and a variety of toxic brominated compounds, such as hydrobromic acid (HBr), which rapidly causes pulmonary edema when inhaled.

Less toxic additives, such as aluminum trihydroxide(ATH), are inefficient and require loading levels so high that the desirable physical properties and characteristics of the finished product are dramatically diminished.

The prior art describes the use of a variety of flame-retardant additives, see “Modern Plastics Encyclopedia,” Vol. 63, No. 10A, McGraw-Hill, Inc., pp. 179-180 (1986). Typical flame-retardant agents include reactive or additive halogenated organic compounds, inorganic fillers, solvents, and special formulations based on phosphorous and ammonium salts.

Those conventional polymeric additives have numerous problems associated with their use. For example, during fabrication of a product, a thermoset polymer resin must have a sufficiently low viscosity to soak or “wet-out” the glass reinforcements prior to curing. This wet-out is necessary to achieve a high cross-link density within the finished product. However, when a fire-retardant powder additive such as ATH is mixed into the resin in the necessary quantities for acceptable fire retardancy, e.g., perhaps as much as 60 parts in 100 parts of total mix, the resin viscosity increases dramatically as the styrenated resin wets-out the additive. As a result, this r viscosity resin no longer has the ability to fully saturate the glass reinforcement fibers.

To overcome this higher-viscosity processing problem, virgin styrene is added to the mixed composition to lower the viscosity back to the required working viscosity range. Consequently, the resin contains a markedly higher quantity of styrene, so that after processing and curing, the finished material contains a disproportionate quantity of cross-linked styrene and polystyrene. The heavily filled material has undesirable physical characteristics such as reduced tensile, flexural and shear strength. The only way to make up for the reduced physical strength characteristics is to produce a thicker, heavier, more expensive part.

Although the excessively high ATH fire-retardant loading does reduce the likelihood of the part to combust when exposed to an open flame or high radiant heat, the ATH inefficiently reduces combustion by liberating bound water. As the decomposition of the ATH continues, the additional styrene constituent makes a major contribution as a combustible fuel source, and provides the composite surface with a greater tendency towards flammability.

In addition, virgin and cured styrene is an egregious smoke-generating compound, which significantly adds to the overall smoke production of the finished material. Therefore, with ATH, there are processing problems which yield weaker parts, and which have the characteristic of generating larger quantities of toxic smoke.

To reduce the fire retardant loading in a thermoset resin, an alternative to ATH is a combination of decabromodiphenyl ether (DBPE) with antimony trioxide (ATO), e.g., less than 20 parts per 100 parts of total mix. However, an additional quantity of styrene is still necessary to reduce the buildup in viscosity.

When compared with ATH during a fire insult scenario, the brominated fire-retardant package is more efficient at reducing flammability of the substrate than ATH. However, the brominated constituent package produces large quantities of dense, acrid smoke which is extremely toxic.

Bromine works as a fire retardant in a pyrolysing composite material by competing with oxygen in the ionization phase of the combustion reaction by generating large quantities of brominated acidic vapor, soot and acrid, thick particulate smoke. The formation of these compounds further reduces the availability of oxygen at the laminate surface, and the negative contributions due to the required styrene dilutent are still present.

Although effective as flame retardants, brominated compounds when burned generate smoke that renders the environment biologically toxic. A significant byproduct of the decomposition of decabromophenyl ether is hydrobromic acid. This acid is notorious for causing pulmonary edema when inhaled, having effects similar to mustard gas used in the first World War. In addition, many other brominated byproduct compounds are produced, which have significant toxicity, including production of suspect carcinogens.

Although products are available that are more easily processed and provide for improved flame retardancy, the trade-off is the production of large volumes of smoke, rich with aggressive biological toxins.

However, the selection of a suitable smoke suppressant for a curable resin is not predictable. The selection is particularly difficult when flame retardants are employed, exacerbated by the complex interaction between the resin and the flame-retarding agent. Although efficient in suppressing the rate of combustion of finished products that incorporate the resin, most flame retardants tend to affect adversely one or more key properties of the resin. For example, many flame-retardant additives are ineffective at producing low density and low toxicity formulations.

It is well known that the flame-retardant and smoke-suppressive properties of additives in resin formulations varies greatly with the nature of the substrate. This is particularly true for intumescent compositions. The rapid formation of a protective char is highly dependent upon such factors as the combustion temperature and viscosity of the melt formed by the burning substrate.

Other considerations can also come into play, even where the properties of the retardant and suppressive properties of the composition are optimal. These considerations include the effect of the additive on the physical properties, color, and molding characteristics of the base resin.

U.S. Pat. No. 3,293,327 describes the production of bicyclic phosphites, phosphonates, thiophosphates, and selenophosphates. These compositions are said to be stabilizers for vinyl halide resins. They are said to be useful as heat stabilizers for vinyl chloride resin, and as antioxidants for fats and oils.

Intumescent, fire-retardant coating compositions containing carbonifics, film-forming binders and phosphorous materials are well known in the art. U.S. Pat. Nos. 3,562,197; 3,513,114; 4,009,137; 4,166,743 and 4,247,435 disclose such compositions containing ammonium polyphosphates as the phosphorous containing material.

U.S. Pat. No. 3,654,190 discloses an intumescent paint comprising a resinous binder, a blowing agent, a phosphorous containing material, a source of chlorine a solvent, an anti-settling agent, a pigment and a surfactant.

U.S. Pat. No. 3,969,291 describes the use of an amide polyphosphate condensate as a fire-retardant additive in an intumescent coating composition. U.S. Pat. No. 3,914,193 discloses the similar use of a crystalline form of melamine pyrophosphate.

U.S. Pat. No. 4,166,743 describes an intumescent flame-retardant coating composition consisting substantially of a film-forming agent, an ammonium polyphosphate, one or more substances which are carbonizable under the action of heat, a dispersant, and optionally a filler. The coating composition additionally contains an ammonium polyphosphate activator weighing 0.5% to 50% of the weight of ammonium polyphosphate. The activator is constituted by at least one salt which contains water of crystallization that is berated upon the composition being heated to about 35 degrees C. As a coating, this material is unsuitable for fabrics.

U.S. Pat. No. 4,743,625 describes a flame-retardant polyurethane product that is produced by mixing and reacting a salt-forming compound with an acidic salt-forming compound containing phosphorus in a polyol and/or a polyisocyanate, and then reacting the polyol and polyisocyanate. That fire-retardant mixture, when exposed to excessive heat, proceeds through two primary reaction phases. First, an early formation of a char layer is intended to slow the oxidative penetration into the foam core substrate, and second, a glassy layer of non-combustible vitrified material is intended to slow the penetration of radiant heat. However, borates and silicates typically melt together, at relatively low temperatures, to form brittle, fragile matrices. The fragile matrices produced add no structural integrity to the char layer profile.

U.S. Pat. No. 4,801,625, describes a flame resistant composition having an organic polymeric substance in intimate contact with a bicyclic phosphorous compound, and a gas producing compound. The patent is silent on the use of bicyclic compounds to attain smoke-suppressed flame-retardant thermoset compositions.

U.S. Pat. No. 5,356,568 describes a solvent-based heat-resistant and fire-retardant coating containing carbonifics, film-forming binders, phosphorous materials. Also described is an application where the coating is sprayed on steel and aluminum plates using a gravity flow gun. Not described are any smoke-suppressing properties, nor the use of the coating with resins or polymer plastics.

The development of additives for use with resins remains a highly empirical art. The predictability of the behavior of the final composition is rare to non-existent. The prior art has largely concentrated on developing highly specific additive combinations for particular resins and end-uses.

This is a particular problem when the fire-retardant additive powder needs to be combined into composite structures and component products such as glass rovings, yarns, cloths, mattes, and knitted fabrics. Typically, this is done by mixing the powder with high-strength thermoset or thermoplastic resins. However, none of the prior art compounds are truly suitable for adding to curable resins.

The following U.S. Patents describe flame retardants to be used with fabrics. However, those patents describe the fabric in a manner and style that is in contrast with the capabilities, functionality and specificity of the desired compounds and products. Exterior electrical cable wraps, door seals, a membrane to reinforce sprayable mastics or coatings or a mesh fabric with undefined intumescent materials are clearly in contradiction with the technical merits and uniqueness of the present invention.

U.S. Pat. No. 6,340,645 describes a flexible laminated fabric comprising a glass fiber web or glass fiber fabric coated with a four-component intumescent composition. That composition is described as being suitable as a hot-gas seal for fire doors, as fire-protection curtains, and as fire-protection windings surrounding individual cables or cable runs. The flexible fabric is intended for external use only to cover or seal a variety of components. The patent does not describe the ability of the intumescent constituent mix to reduce smoke when exposed to open flame. Neopentyl glycol and ethylene glycol phosphates have the propensity to generate smoke upon thermal decomposition. This is undesirable. That patent is extremely vague on the mechanism and smoke characteristics of the preferred polyol partial phosphates. The inorganic frame-forming candidate compounds are simple inorganic compounds which do not contribute significantly to structure.

U.S. Pat. No. 6,205,728 describes a laminated building component composed of a rigid resilient composite panel which is covered by a membrane. That membrane is selected from a group of non-combustible materials such as glass, quartz, carbon or stainless steel. The membrane is bonded to the panel with an adhesive and coated with a thin film of fire-protective intumescent coating. That membrane serves as a lath to hold and reinforce a spray, brushed or rolled intumescent coating. The patent is silent on the composition of the fire-protective intumescent coating, and the coating's ability to reduce surface flammability or reduce smoke generated by the under-laminate structure.

U.S. Pat. No. 6,096,812 describes a low density epoxy-based intumescent fire-resistive mastic coating with means for reinforcing the mastic with a carbon fiber mesh. That reinforced coating is strictly a surfacing treatment. Epoxies have a propensity to generate significant quantities of acrid smoke which can render an environment toxic. Additionally, the coating requires “at least one spumific” comprised of an isocyanurate. Isocyanurates are organic compounds containing nitrogen which can form hydrogen cyanide (HCN) as a thermal decomposition product contributing significantly to the toxic gas environment. That is obviously undesirable.

U.S. Pat. No. 6,001,437 describes a method for making high-temperature glass fiber by treating E-glass fiber with selected acids and then treating the fiber with organo-metallic material. Additionally, the patent describes the use of the fiber in thermal protective structures. The open-weave mesh fabric is comprised of at least one layer of thermoplastic resin that has been pre-coated with subliming and/or intumescent material. The fabric may be pre-formed into a self-supporting structure or embedded into a pre-existing structural automotive container.

Not described are specifics as to the constituents or processing ranges of the subliming or intumescent materials. No mention is made of any chemical mechanisms which can reduce the flammability or smoke generation of the thermoplastic layer or underlying substrate.

In a combustion scenario, burning polyproplyene thermoplastic produces particulate smoke, mostly carbon dioxide (CO2), some carbon monoxide (CO) and water (H2O). Conversely, polyvinyl chloride thermoplastic, which does have an inherent fire-retarding characteristic, combusts to form large quantities of hydrochloric acid (HCl) and acrid, chlorinated organic compounds. Hydrochloric acid vapor is extremely toxic for human tissue. A common result of exposure to hydrochloric acid rich smoke is impaired vision, respiratory pain and narcosis, resulting in confusion and possible loss of consciousness. All of these effects are undesirable. The patent is silent on the ability of the thermal protective layer to address the biologically toxic byproduct species created during combustion of the thermoplastic glass layer or the underlying thermoplastic substrate.

The physiological effects of exposure to heat in fires and/or the resultant toxic smoke can result in varying degrees of incapacitation, permanent injury or death. Visual obscuration and painful irritation of the eyes can impair or reduce the efficiency of egress due to psychological and/or physiological effects. Breathing difficulties, lung inflammation, narcosis, and respiratory tract injury are physiological hazards potentially present in fire scenarios. Narcotic gases, e.g., carbon monoxide, hydrogen cyanide, and reduced oxygen can affect the nervous and cardiovascular systems, causing confusion and a period of intoxication, followed by collapse and loss of consciousness, followed ultimately by death from asphyxiation. Any prior-art compounds that include materials that produce these effects are undesirable.

Therefore, it is desired to provide a non-toxic additive powder, a cloth fabric reinforcement material, and an adhesive binder. More particularly, for the reasons stated above, it is specifically desired to provide a finished product that does not include any of the following classes of compounds:

Brominated compounds, including decabromodiphenyl ether (DBPE, Deca-BDE), octabromodiphenyl ether (Octa-BDE), pentabromophenyl ether (Penta-BDE), hexabromocyclododecane (HBCD), decadbromobiphenyl ether (DeBBE) as well as other polybrominated biphenyls (PBB), tetrabromo phthalic anhydride and all related aliphatic and aromatic brominated compounds.

Polymeric binder resins, e.g., polyester, vinyl ester, epoxy, phenolic, etc., and adhesives which have had tetrabromobisphenol- A and/or derivatives of such brominated monomer flame-retardant compounds incorporated into the backbone of the resin chain during the manufacturing process.

Heavy metals such as the bromine synergist antimony trihydroxide (ATO).

For the purpose of the present invention, any prior-art article of manufacture containing any compounds in any of the above classes are considered irrelevant as they yield products with undesirable physical and flame-retardant characteristics that are inconsistent with current building and life safety regulatory standards, and are physiologically toxic.

### SUMMARY OF THE INVENTION

The invention provides a fire-retardant and smoke-suppressing surfacing and reinforcement fabric. This novel composition includes an additive powder, a cloth fabric reinforcement material substrate, and an adhesive binder.

In one embodiment, the additive powder is incorporated on and within a matrix profile of the fabric, and held permanently in place by the adhesive binder.

The fabric can be selected from a wide assortment of commodity and specialty industrial textile materials in a number of profile thicknesses dependent on the particular application.

In composite resin and reinforcement applications, a single-ply surfacing veil can be used. A multi-layer stacked fabric schedule positioned at a surface is also possible. The fabric can be positioned at the ends or within a partial section of a part during fabrication for enhanced localized fire and smoke protection.

Alternatively, the fabric can be used as a primary reinforcement material in a laminate, such as a skin in a balsa cored “sandwich” panel, and other cellular foam constructions.

These applications can be employed in a range of fabrication processes, such as pultrusion, filament winding, compression molding, resin transfer molding, vacuum assisted resin transfer molding, hand lamination, press molding, reaction injection molding, impression molding, and secondary processes. When incorporated into a thermoplastic under heat and pressure, the cloth can be thermoformed, vacuum formed, or re-formed.

### BRIEF DESCRIPTION OF THE DRAWINGS

FIG. 1 is a flow diagram of a process for manufacturing an intumescent additive powder according to the invention;

FIG. 2 is a flow diagram of a process for manufacturing a flame-retardant and smoke-suppressive fabrics according to the invention;

FIG. 3 is a flow diagram of a process for manufacturing an intumescent additive powder composition with a solid hot-melt adhesive applied to a fabric according to the invention;

FIG. 4 is a flow diagram of a process for making a fabric with an additive powder constituent using heating and cooling steps according to the invention;

FIG. 5 is a flow diagram of a process for applying a powder coating to a fabric according to the invention;

FIG. 6 is a flow diagram of a process for applying an additive powder to a fabric according to the invention; and

FIG. 7 is a flow diagram of a process for adhering an additive powder to a fabric according to the invention.

### DETAILED DESCRIPTION OF THE PREFERRED EMBODIMENT

Additive Powder

The invention provides a flame-retardant and smoke-suppressive powder that can be added to resins and used in manufacturing processes, specifically manufacturing processes that incorporate the powder into fabrics. When the powdery additive according to the invention is mixed with a resin, the propensity of the otherwise untreated resin to combust, generate toxic smoke, and transmit heat when exposed to an open flame or excessive heat is significantly reduced.

The powdered composition according to the invention is “active.” By being active, the composition has a latent ability to intumesce or foam when a specific temperature is reached. This is due to the nature of a blowing agent, which is a part of the composition. In a preferred embodiment, that temperature of flame or heat retardation is 350 degrees Centigrade. At this temperature and above, the cured or hardened resin/composite structure resists combustion, self-extinguishes without the direct application of a flame extinguisher, and produces a substantially smaller quantity of less-toxic smoke than similar prior-art materials.

In a preferred embodiment of the invention, the composition of the additive powder, according to weight of ingredient classes, is as follows.

| Ingredient Class | Wgt. % Range |
|---|---|
| a) catalyst | 30.0 to 41.0 |
| b) carbonific | 22.0 to 29.0 |
| c) blowing agent | 15.5 to 17.5 |
| d) cementitious inorganic binder | 21.0 to 25.0 |
| e) ceramic | 2.50 to 5.00 |

The ingredients of the additive are mixed and blended at ambient (room) temperature until fully incorporated into a uniform, homogeneous composition. The additive in its final form is a white fine powder that can be added to a resin.

Each class of compounds contributes a specific property to the formulation that is advantageous to the success of the invention in yielding a reduced propensity for the resin so treated to burn, smoke, generate toxic gases, or transmit heat.

Catalyst

The ingredients in the catalyst class include phosphorous-containing materials such as ammonium polyphosphate and tris (betachloroethyl) phosphate at approximately a 9:1 ratio. Under the influence of heat, from a fire or otherwise, the catalyst decomposes, yielding phosphoric acid.

The reactive phosphoric acid produced by the breakdown of the catalyst compound reacts with both the amine function of melamine and the hydroxy function of the carbonific, as described below, to produce water, carbon dioxide, urea and ammonia. In addition, under the applied and generated heat, the organic components of the resin composite, as described below, are degraded producing and contributing to an insulating layer of char.

In other embodiments, the phosphate material is selected from the group consisting of ammonium polyphosphate, tris(beta-chloroethyl) phosphate, guanidine phosphate, urea phosphate, melamine phosphate, monoammonium phosphate, diammonium phosphate, and mixtures thereof.

Carbonific

In the preferred embodiment, the primary ingredient of the carbonific class of material is dipentaerythritol or tripentaerythritol. The carbonific, simply stated, is a source of carbon. The purpose of the carbonific is to produce a carbon char layer that insulates the underlying uncombusted resin and finished structure from greater thermal damage. It should be understood that the resin itself, with which the flame-retardant additive powder is mixed, can also be a source of carbon, and thus, a carbonific. In the case where the resin decomposes to a carbon-rich byproduct, the amount of primary carbonific can accordingly be adjusted downward when the resin is to be relied upon as a carbonific for the combustion process.

In other embodiments of the invention, the carbonific material can be selected from the group consisting of dipentaerythritol, pentaerythritol, pentaerythritol, polyurethane, phenol, triethylene glycol, resorcinol, inositol, sorbitol, dextrin, and starch. The carbonific material can include secondary carbonifics, e.g., a chlorinated paraffin containing about 70%, by weight, of chlorine and a chlorinated paraffin containing about 40% by weight, of chlorine. The weight ratio of 70% chlorinated paraffin to 40% chlorinated paraffin is preferably from about 2:1.

Blowing Agent

The blowing agent is primarily comprised of melamine. Heat decomposition of the melamine produces nitrogen, ammonia, urea, water, carbon dioxide, etc. These gases swell and expand the volume of the forming carbonaceous char. This expansion produces a multi-cellular, swollen char, which insulates and protects the underlying substrate from additional heat.

In other embodiments, the heat activated blowing agent is selected from the group consisting of urea, butyl urea, benzene sulfonyl-hydrazide, melamine phosphate, melamine polyphosphate, melamine borate, chloroparaffin, guanidine and glycine.

Cementitious Inorganic Binder

The heat resistant cementitious inorganic material can include a mixture of suitable heat resistant materials, whose process of hydration is strongly dependent on temperature, e.g., calcium aluminate cement and silica flour. Calcium aluminate cement and silica flour undergo a dissolution-precipitation reaction when exposed to water or steam vapor. The resultant cementitious structural matrix is dispersed throughout the char adding rigidity, structure and strength to the swollen char layer. The inorganic material is also multifunctional. After formation, the cement structure serves as a heat deflector against higher radiant heat and thermal pressure gradients. The strong cementitious layer produced by the present invention should be distinguished from the typically brittle vitreous layer produced by prior art inorganic binders.

Ceramic

The heat resistant ingredients of the ceramic class of materials are preferably solid ceramic or treated silica spheres, hollow or solid, or combination there-of. The preferred ceramic is made of spheres about 10 to 500 micron in diameter. These constituents perform a number of functions: 1) to work in conjunction with, and contribute to the protective cementitious char matrix by enabling it to be resistant to very high temperatures; 2) to contribute to the rigidity and structure of the swollen char; 3) to reflect infrared (IR) radiation; 4) to absorb IR and reradiate heat by emissivity; and 5) to suppress smoke and afterglow.

After the reaction cycle that forms the swollen and insulative char has terminated, the ceramic and cementitious inorganic components dispersed throughout the carbonaceous barrier prevent even higher temperatures and high velocity thermal pressure gradients from penetrating to the substrate. Other embodiments can include quartz, mica and other inorganic materials, which possess high emissivity values.

After the above ingredient classes have been blended together to form the additive powder, the powder is mixed with an adhesive binder.

Adhesive Binder

The inventive constituent is an adhesive binder, which provides adherence of the fire-retarding and smoke-suppressing powder to a fabric substrate. The relative dry weight percentage of the adhesive binder to the fire-retarding powder is 1% to 20% of the additive and adhesive combined weight, depending upon the physical, processing and adhesion properties of the binder. In the preferred embodiment, the binder is a resin such as styrenic, olefinic, acrylic, cellulosic, polyester, phenolic, rosin, shellfish resin, polyamide, an aliphatic adhesive binding compound, or an aromatic organic adhesive binding compound.

Any compound or material that exhibits an ability to hold the fire-retarding composition on and within a cloth fabric may be employed. In the preferred embodiment of the invention, the adhesive binder makes no contribution as a combustible fuel source nor generates smoke when exposed to open flame or high radiant heat.

In one embodiment of the invention, the adhesive binder can be a fine hot-melt adhesive powder. This hot-melt powder is mixed with the fire-retarding powder during the initial manufacturing process. When applied to a fabric, for example with a dry-powder coater. The fire-retarding/hot-melt adhesive powder mixture is deposited on the fabric and then heated. The fully dispersed adhesive melts to a liquid when exposed to elevated processing temperatures. The liquefied hot melt elutes upon the fire-retarding powder and coats the underlying fabric. Upon cooling, the hot-melt adhesive resets to a solid, binding and holding the fire-retardant powder on and within the fabric. Solid hot-melt adhesive binders can be a composition of linear saturated polyester, polyethylene, polypropylene, polymethylmethacrylate, polyethyleneterephthalate, polyetheretherketone, or numerous other thermoplastic resins, individual or mixtures there-of. Additionally, the adhesive binder can be selected from other candidate families of hot-melt adhesives, such as cellulosics or phenolics.

In another embodiment of the invention, the pure fire-retarding and smoke-suppressing powder is first deposited upon the fabric in a production process. The combined fire-retarding powder and fabric construction is then sprayed with a finely atomized aqueous dispersed adhesive solution. The solution coats the combined powder and fabric construction. Upon drying, the residual adhesive binds the powder firmly to the fabric.

In addition to application of an adhesive solution by spraying, a dilute slurry of liquid adhesive, aqueous solvent and the fire-retarding powder can be used. The liquid adhesive can be selected from a broad range of commercially available water based acrylics, vinyl acrylics, styrene acrylics, latex, urethane, or other emulsion adhesive families. Example manufacturing processes that can coat flexible substrates such as a fabric include dipping, roll coating, knife-over, pinch rolling, squeegee or draw down.

The binder can also be an adhesive resin dissolved in a liquid organic solvent. The solvent may be selected from a wide range of common industrial liquids, such as methyl ethyl ketone, acetone, heptane, toluene, xylene, alcohols, or other aliphatic or aromatic solvent, either individually or in combination. In this case, the adhesive binder can be a polyester, copolyester, polyureathane, cellulose acetate butyrate, nitro cellulose, or chlorinated rubber, just to name a few. The candidate processes of application to the fabric are similar to those described above for the aqueous adhesive binder combination.

In the prior art, the additives are usually highly specific additive combinations for particular resins and end-uses. For example, the flammability of plastic resins was generally improved by incorporating reactive elemental bromine in some form, a halogen, combined with antimony trioxide, a heavy metallic compound, into the resin medium. However, on exposure to an open flame or radiant heat ignition source, those resins generate and release noxious smoke with poisonous brominated fumes and possible carcinogenic compounds, rendering the environment biologically toxic. Any such compounds should be avoided.

In contrast, the additive powder according to the invention is a non-brominated composition, which, as an advantage, contains no heavy metallics. Upon incorporation with a polymeric medium, the powder substantially reduces the propensity of the finished material to combust, generate toxic smoke and transmit heat when exposed to an open flame or excessive heat.

As an advantage, the additive powder according to the invention can be mixed with a broad range of classes of resins, depending on the desired manufacturing processes, physical characteristics, and uses of the end products.

For example, the resin can be a curable or hardenable material, such as a styrenic, olefinic, acrylic, cellulosic, polyester, or polyamide or any other class of resin. In a preferred embodiment, the resin is a styrenic such as those commonly used in the manufacture of fiberglass, reinforced structures.

The resin can also be any class of resins used in resin transfer moldings (RTM), bulk moldings, sheet moldings, fiber reinforced polymer pultrusions, compression moldings, vacuum injection moldings, vacuum assisted resin transfer moldings (VARTM), pressure bag moldings, hand lay-ups and spray-ups, filament windings, cold press moldings, continuous laminating, rotational moldings, encapsulations and pre-impregnations.

Fabric

In manufactured products according to the invention, the additive powder and adhesive binder, as described above, are combined with composite reinforcement materials and components such as glass rovings, yarns, veils, cloths, surfacing mattes, non-woven fabric, woven fabrics, knitted fabrics, all glass fabrics, all carbon fabrics, Kevlar fabrics, ceramic fabrics, Nomex fabrics, basalt fabrics, and air texturized fabrics, generally “fabrics.”

In the preferred embodiment, the cloth fabric weights 33.0 to 1400.0 grams per square meter. The fabrics are bound by high strength thermoset or thermoplastic resins weighting 9.0 to 1050.0 grams per square meter of the cloth fabric. The additive powder can weight 120.0 to 6250.0 grams per square meter of the cloth fabric.

Surfacing mattes or veils and structural reinforcement fabrics can be combined to fabricate finished products that are light weight, high strength polymeric composite components. Closed and open cell expanded foams and balsa wood can be used to impart varying performance characteristics to meet a diverse spectrum of traditional, as well as new and innovative requirements.

Surfacing mattes or veils have traditionally been used to provide a pleasing esthetic appearance, or to draw resin to the surface of the part to enhance and maximize the corrosion resistance of the part. In either case, the surface is enriched with a disproportionate quantity of resin compared to the inter-laminate resin to reinforcement ratio.

Because synthetic hydrocarbon resins are refined and processed from crude oil, virgin or untreated polymeric resins burn vigorously and aggressively when exposed to open flame. Treating a resin with additive fillers reduces the resin's ability to combust. However, fillers reduce the cross-link density of the resin to the reinforcement, and thereby weaken the finished part.

To overcome this reduction in physical strength characteristics, a heavier thicker part profile must be produced. This is contrary to the advantage of industrial composite technology where “lighter and stronger” is the operative focus and paradigm.

A fabric assembly comprised of reinforcement fibers and the fire-retardant and smoke-suppressing powder according to the invention overcomes the above-noted disadvantages of highly loading a resin with fire-retarding fillers. By putting an extremely high concentration of the fire-retardant and smoke-suppressing powder in a surfacing mat, veil or fabric, the outermost surfaces of the part can be fire hardened and will suppress smoke.

The interior of the laminate could potentially be filler free, with the fire retardant oriented where the retardant is needed, i.e., at the point of contact with an open flame or high radiant heat. When a fire-retarding additive is necessary for a composite specimen to pass an exceptionally aggressive fire test protocol, then the current invention requires less additive than would be necessary with prior-art fire-retardant additives.

Encapsulated within and at the surface of a resin-reinforced structure, the fire-retardant and smoke-suppressing fabric according to the invention can be used for a variety of fire-retarding, smoke-suppressing and toxicity-minimizing uses. The orientation of additive at the exposed surface of an assembly reduces the ability of the substrate to burn or generate smoke.

The fire-retarding-powder-filled fabric according to the invention reduces an assembly's ability to ignite when exposed to open flame or high radiant heat, reduces the surface-flammability characteristics, stops the spread of flame, minimizes smoke density generated by a combustion event, increases the time to structural failure of the assembly in a catastrophic fire or high thermal event, and suppresses biologically toxic gas emissions from the underlying substrate in a burning or smoldering condition.

As the inter-surface substrate of the finished product, e.g., a cloth fabric impregnated with the fire-retarding powder, attempts to combust in the presence of high radiant heat or an open flame, the catalyst constituent decomposes at the start of the pyrolyzing process, releasing a strong phosphoric acid by-product. This phosphoric acid dehydrates the pyrolyzing polymer resin and reacts with the alcohol dipentaerythritol carbonific to form initiator based esters. Halogen gases are also formed and liberated from the chlorinated paraffins. This series of reactions and decompositions catalyzes the formation of water and expedites the formation of a char layer. Decomposition of the blowing agent yields large volumes of non-flammable gases and additional char, causing the char to swell.

The calcium aluminate cement hydrolizes in the presence of the water vapor produced during the formation of the char layer. The hydrolyzed calcium aluminate cement proceeds through a deposition and precipitation reaction with the silica flour to form a hardened cementitious structural matrix, unobtainable by the prior art. This adhesive cement structure stays intact, and in contrast with the prior art, remains stable during extremely high temperatures, supporting the insulating char layer formed by the intumescent additives in concert with the plastic soot, i.e., chiefly carbon produced by the incomplete combustion of the plastic polymer.

After the reaction cycle is complete, the carbonaceous material, supported by the cementitious barrier structure, prevents even higher temperatures and high velocity pressure gradients from penetrating the underlying laminate sub-structure. This is a highly desirable effect not possible with the brittle prior art vitrified materials.

Note, this is not a typical Portland cement reaction that has a long “gel phase” to eventual cure. Instead, the water, calcium aluminate cement, and silica flour deposition and precipitation reaction occurs very rapidly at elevated temperatures, i.e., elevated kinetics. Prior-art compositions cannot achieve this unexpected high-speed reaction.

Manufacturing Processes

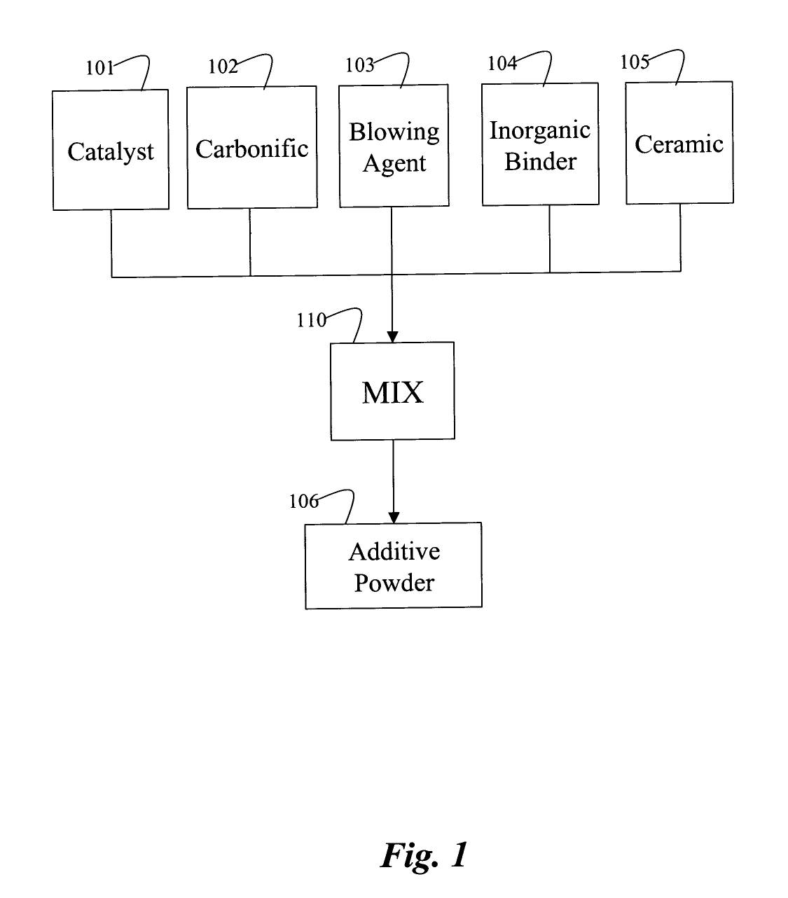

FIG. 1 shows a process for manufacturing the additive powder 106 according to the invention. The process basically mixes the catalyst 101, the carbonific 102, the blowing agent 103, the inorganic binder 104 and the ceramic 105, all powders, into a uniform powder composition. The powder composition can be sifted, milled or further processed as described below.

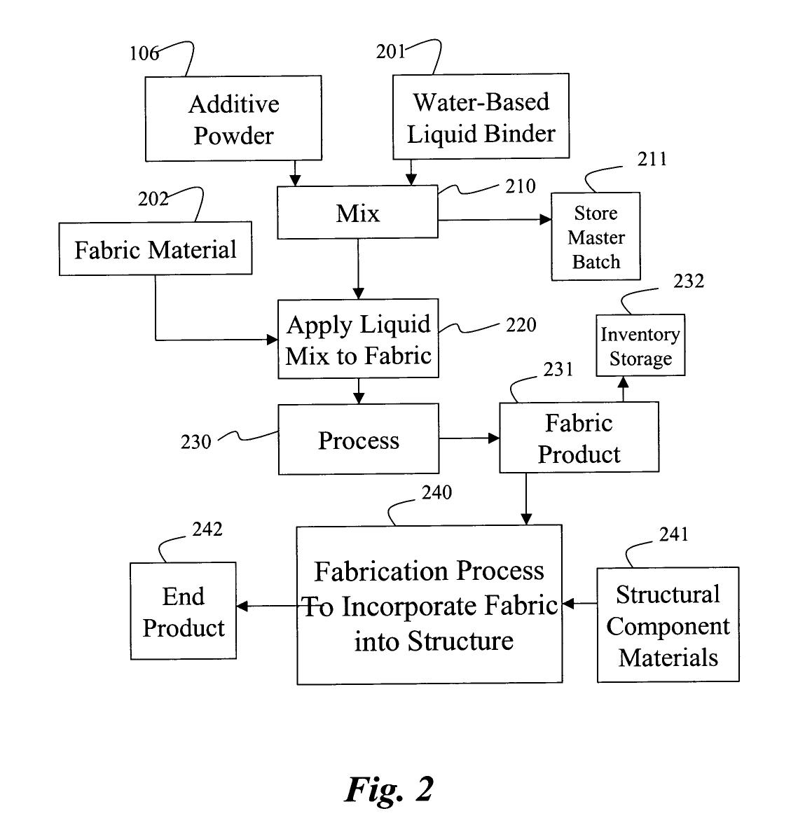

FIG. 2 shows a process for manufacturing a fabric product to be integrated within an end product 242. First, the additive powder 106 is mixed 210 with a water-based liquid binder 201. The result can be stored as a blended master batch 211 or applied 220 as a liquid mix to a fabric material 202 and processed 230, e.g., dried by heating, to produce a dry fabric product 231. The dry fabric product 231 is stored typically in rolls. These rolls can be kept for extended periods in inventory storage 232 for later use, if so desired. The fabric product 231 is incorporated with structural fabrication materials 241 during a fabrication process 240 to produce an end product 242 containing the fabric product 231 within a surface of the end product 242.

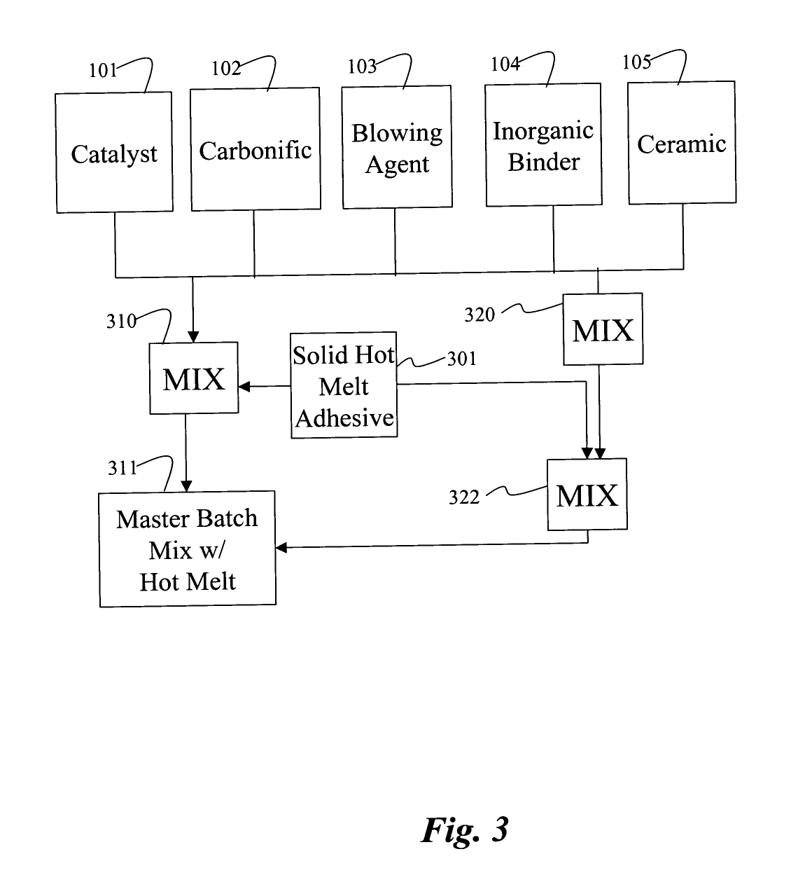

FIG. 3 shows a process for manufacturing the additive powder composition with a solid hot-melt adhesive 301. The process can be accomplished two ways. First, the catalyst 101, carbonific 102, blowing agent 103, inorganic binder 104 and ceramic 105 are mixed 310 with the solid hot-melt adhesive 301 in one blending step to produce an additive master batch mix with hot melt 311. Second, the catalyst 101, carbonific 102, blowing agent 103, inorganic binder 104 and ceramic 105 are mixed 320. This additive powder mix 320 is then mixed 322 again to produce the additive master batch with hot melt 311.

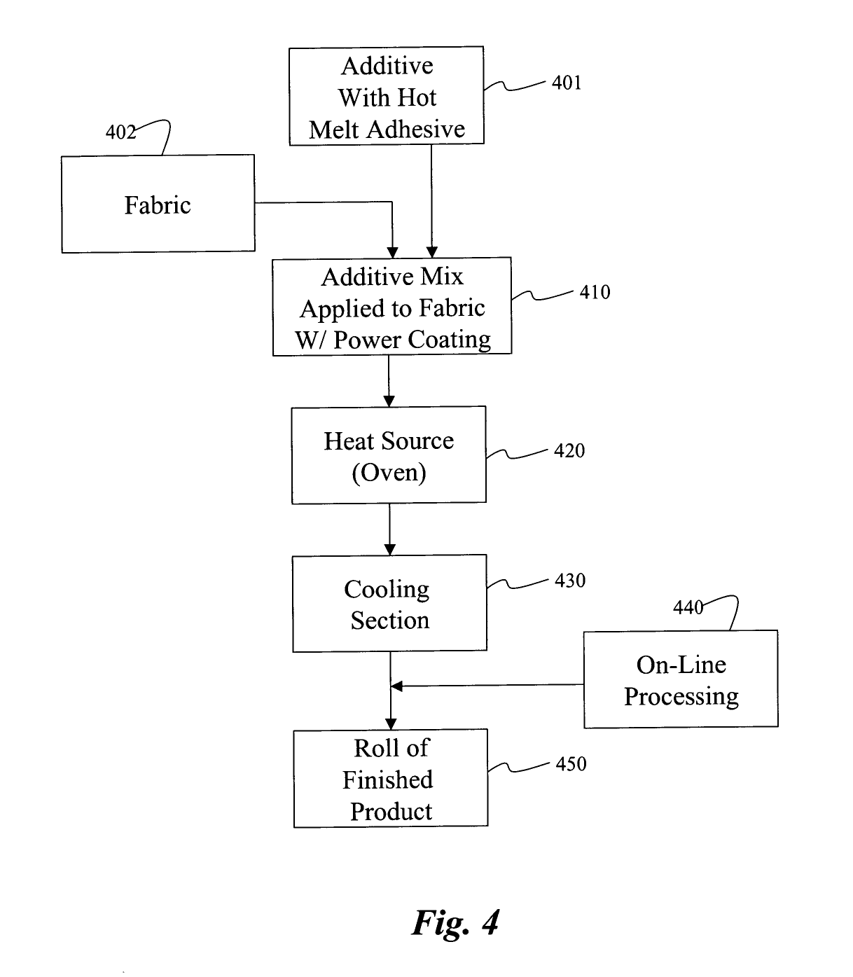

FIG. 4 shows a process for making a fabric with additive powder constituent using heating and cooling steps. Additive powder with pre-mixed hot-melt adhesive 401, produced as described above, is applied to a fabric 402 by means of a powder or roll coater machine 410. The fabric with powder coating proceeds through a heat source, e.g., an oven, and is cooled 430. Then, the fabric can be processed 440 directly on-line or stored as rolls of finished product 450 for processing at a later time.

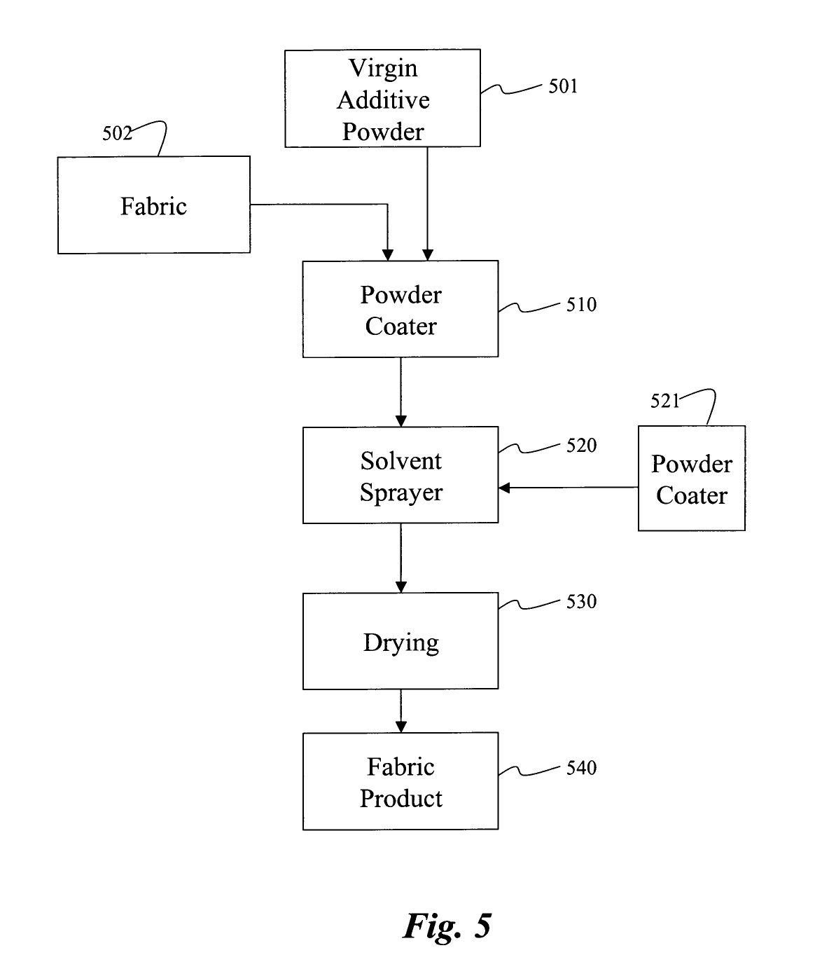

FIG. 5 shows a process for applying a powder coating, produced as described above, to a fabric and binding the powder to a fabric by employing a solvent spray apparatus. The process applies the additive powder 501 to a fabric 502 using a powder or roll coater machine 510. A solvent sprayer 520 sprays an organic solvent based adhesive binder on to one or both sides of the coated fabric. Additional additive material can be applied with a second powder coater 521. The additive fabric is dried 530 to produce the finished fabric product 540.

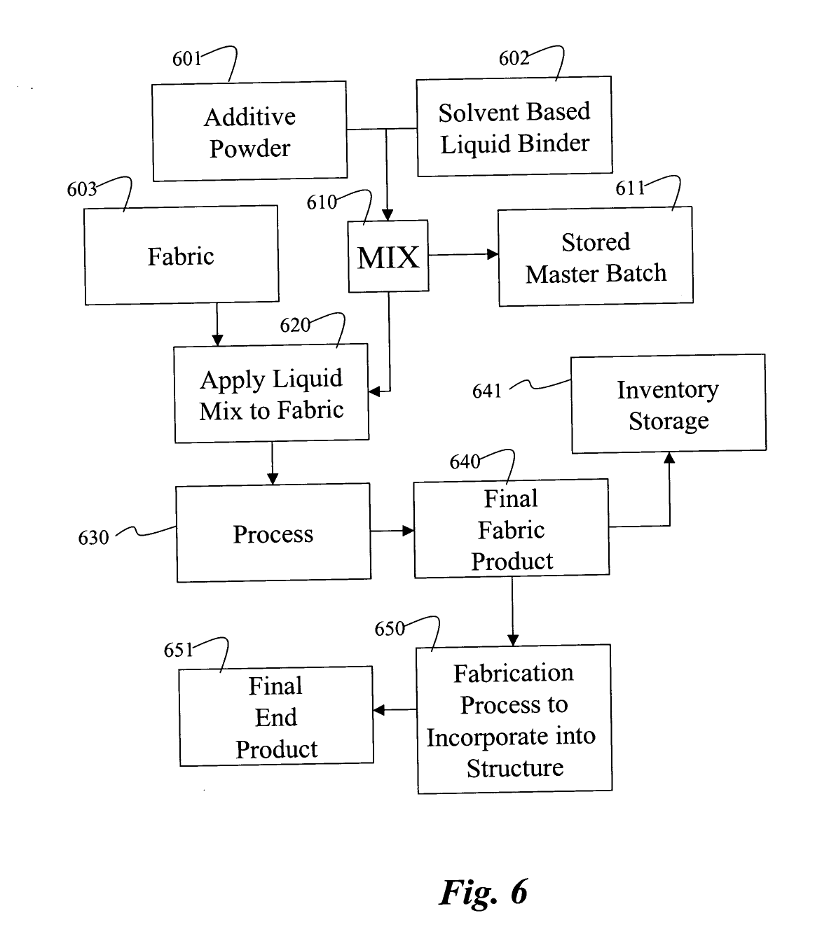

FIG. 6 shows a process for applying a slurry including the additive powder 601 and a solvent based liquid binder 602 to produce a final fabric product 640, and then a final end product 651. First, the additive powder 601 and the solvent-based liquid binder 602 are mixed 610 to form a slurry. The slurry can be stored as a master batch 611. After mixing 610, the slurry is applied 620 to a fabric 603 and processed 630 into a final fabric product 640. The final fabric product 640 can be put in inventory storage 641. The final fabric product 640 can be used immediately in a fabrication process whereby it is integrated using a structural fabrication process 650 to manufacturer a final end product 651.

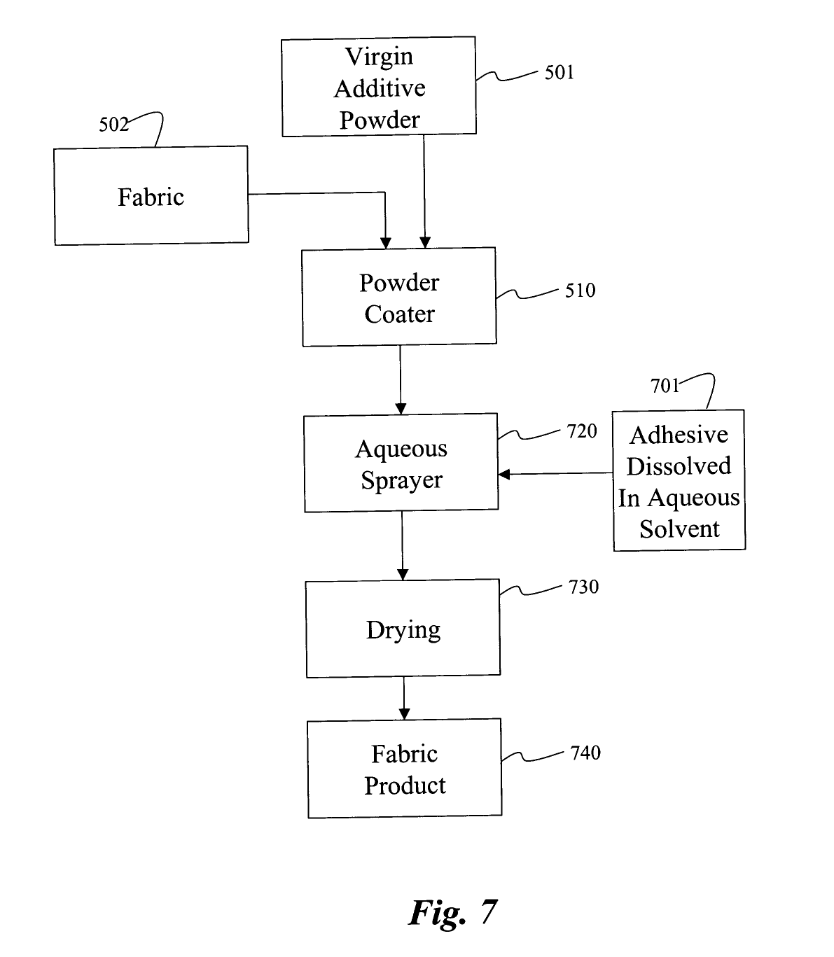

FIG. 7 shows a process for adhering the additive powder 501 to the fabric 502 with a water based adhesive by means of an aqueous sprayer 720. First, the additive powder 501 is applied to the fabric 502 using the powder coater 510. The coated fabric is then sprayed with an adhesive dissolved in aqueous solvent 701 by means of an aqueous sprayer. The fabric proceeds through a drying 730 step to produce the final fabric product 740.

Test Results

Standard testing methods and protocols are used by many authorities to determine fire-hazard and surface-burning characteristics of building materials, e.g., ASTM E-84 Standard Test Method for Surface Burning Characteristics of Building Materials. It is accepted that test results with higher values for flame spread and smoke obscuration are indicative of a greater fire hazard and more dangerous smoke production. Comparative results for the ASTM protocol are listed in Table A.

TABLE A

| Property | Invention | Typical Prior Art |
|---|---|---|
| Flame Spread Ratio | 19.2 | 25.0 |
| Smoke Obscuration | 350 | 980+ |
| Toxicity | None | High |

As seen from the Table A, the flame spread ratio and smoke obscuration results for the invented material are about ⅓ that of a typical prior-art result. This is a significant reduction. More surprisingly and importantly, no toxic by-products are produced by the invented material and a significant amount of the registered obscuration is water, by chemical design.

Smoke obscuration measurement by the ASTM E-84 protocol is based upon the attenuation, i.e., change in concentration, of a white light beam by smoke accumulating in a chamber. Results are derived from measuring optical density as absorbance within the chamber. The photometric scale used to measure smoke by this method is similar to the optical density scale for human vision. Hence, obscuration can result from such combustion byproduct species as particulate matter, e.g., soot, or condensed gas, e.g., water vapor.

Because particulate smoke generated by pyrolyzing brominated polymers is biologically toxic, unlike water vapor, many regulators measure the total quantity of these toxic constituents by ASTM E-1354 using, e.g., Cone Calorimetry. This apparatus employs red laser spectrophotometry to measure the specific mass of particulate smoke generated during the combustion of a sample specimen in comparison to the total mass loss of the test specimen as shown in Table B.

TABLE B

| Property | Invention | Typical Prior Art |
|---|---|---|
| Initial Mass | 40.6 grams | 40.6 grams |
| Final Mass | 23.6 grams | 26.2 grams |
| Smoke Obscuration: | | |
| Ave. Smoke Yield (g/g) | .057 | .106 |
| Total Smoke Release (g) | 13.979 | 26.130 |

As seen from Table B, the release of particulate smoke from a specimen employing the invented material is about ½ of that of typical prior art results with the identical inter-laminate brominated fire retardant.

The ASTM E-84 smoke obscuration results can be assessed in conjunction with the ASTM E-1354 total smoke-release results. Tested typical prior-art specimens are compared with specimens employing the current invention. The reduction in toxic smoke generation is dramatic. The corrected value of E-84 smoke obscuration, excluding the water vapor, is reduced from a smoke index value of 350 to about 187. The particulate smoke is about 38% of the typical prior art compound. These are surprisingly better results.

As stated above, the additive powder is a combination of functional classes: a catalyst, a carbonific, a blowing agent, an inorganic binder, and a ceramic. Each of these classes of the composition contributes a specific property to the fire-retarding and smoke-suppressing layer, and each is critical to the success of the compound in overcoming the disadvantages associated with prior-art toxic fire retardants.

When incorporated into a fabric substrate, and upon exposure to open flame or high radiant heat, the active material operates stepwise in the following orderly form.

First, the catalyst decomposes to release a strong acid by-product. The by-product dehydrates the pyrolysing resin and reacts with the carbonific to form initiator based esters. After this series of reactions and decompositions, the original strong acid by-product of the catalyst decomposition is also released for further reaction to continue the cycle. Unsaturated compounds are formed with subsequent charring.

Second, as the temperature rises, the catalyzed carbonific begins to decompose along a much different route and at much lower temperatures than would occur for a non-catalyzed carbonific. The carbonific binds with the dehydrated polymer to lock a forming carbonaceous layer to the substrate. The forming carbonaceous structure begins to add integrity to the char layer. Additionally, the decomposition of the carbonific constituents produces large volumes of char, carbon dioxide and water. The original strong acid by-product of the catalyst decomposition continues to be regenerated as the reaction cycle continues.

Third, the blowing agent begins to decompose to yield large volumes non-flammable, oxygen-replacing gases and additional char. The carbonaceous layer then begins to bubble, forming a swollen insulative heat shield.

Fourth, the inorganic binder constituents perform several functions. They form a cementitious structure which protects and holds the carbonaceous layer in place. These constituents also add to the rigidity and strength of the reinforcement fabric. They reflect infrared radiation (IR) and are not easily dislodged by high velocity flame fronts. Furthermore, they suppress smoke and afterglow.

Fifth, after the reaction cycle is complete, the ceramic components dispersed throughout the cementitious/carbonaceous barrier, prevent, by means of IR reflection and emissivity, even higher temperatures and high velocity pressure gradients from penetrating the laminate.

In the preferred embodiment of the invention, the fabric composite material is non-combustible and does not make a fuel contribution in the event of exposure to a pyrolyzing event or radiant heat. Any textile material that meets a broad physical description of cloth can be used for a large number of industrial applications.

The cloth can comprise glass, carbon, Kevlar, ceramic, Nomex, basalt or other commercially available synthetic material such as polyester, Dacron, acrylic or any other man made fabric material, or mixtures thereof which can be assembled in some fashion into a cloth or fabric material. Natural materials can be anything from cotton to hemp to burlap. The cloth can be woven, non-woven, matte, felt, needled, or a sandwich structure of any of these cloth constructions, or, a composite design combination of these various materials.

The additive powder according to the invention can be applied to the fabric by a variety of methods. The pure, dry powder can be mechanically applied to the fabric by: deposition, rubbing, or inserting on, or within, the fabric material.

A pure liquid slurry of the fire-retarding powder and an evaporative liquid can be applied by spraying, dipping, roll coating or other technique common to the paper or textiles industries, where the liquid slurry or foam is incorporated on and into a fabric and the evaporative liquid is driven off in a second stage by a variety of techniques. These techniques could include convective heat, exposure to quartz heating elements, vacuum, and the like.

To reduce manufacturing time and expense, a slurry mixture of the fire-retarding powder and a liquid adhesive binder with or without an evaporative diluent can be applied to the fabric by spraying, dipping, roll coating or other common textile or paper industrial techniques.

These techniques can be used to produce asymmetric layers in the cloth fabric, e.g., a fire-retarding layer on the outside and a reinforced layer on the inside. In the preferred embodiment, the strands which comprise the cloth fabric are open sufficiently to hold a substantial quantity, by weight, of the additive powder as compared to the weight of the fabric.

In the preferred embodiment, the fabric to powder weight ratios range from 1:2 to 1:8, excluding the adhesive binder. In addition, the preferred fabric has an open structure or pore volume to enable permeability of a polymer fluid. Permeability allows polymer resins to flow or permeate through the filled fabric, wetting or saturating the powder and cloth fabric from any direction. For quantification, permeability is typically measured by ASTM D737-96 “Test Method for Air Permeability of Textile Fabrics.” The preferred permeability would be 0.5 to 350 cubic centimeter/square centimeter/second.

In the preferred embodiment, the adhesive binder makes no contribution as a fuel source in the event of a fire episode. The binder is completely compatible with the assembly when it is integrated, affixed or attached, and has an adequate adhesion so that the cloth fabric can be handled, cut, stacked, draped, wound, molded, or stitched without dusting or removal of the powder. The binder is stable under normal processing temperatures and pressures so that the cloth can be handled by conventional manufacturing and conversion processes.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A flame-retarding and smoke-suppressing article of manufacture comprising, by weight:
a cloth fabric 33.0 to 1400.0 grams per square meter;
an adhesive binder 12.0 to 1050.0 grams per square meter of the cloth fabric; and
an additive powder 120.0 to 6250.0 grams per square meter of the cloth fabric, the additive powder further comprising, by weight:
a phosphate-based catalyst 30.0 to 41.0%;
a carbonific 22.0 to 29.0%;
a blowing agent 15.5 to 17.5%;
a cementitious inorganic binder 21.0 to 25.0; and
a ceramic 2.50 to 5.00.

2. The article of manufacture of claim 1 wherein the phosphate-based catalyst is selected from the group consisting of ammonium polyphosphate, tris(beta-chloroethyl) phosphate, guanidine phosphate, urea phosphate, melamine phosphate, monoammonium phosphate, diammonium phosphate and mixtures thereof.

3. The article of manufacture of claim 1 wherein the carbonific is selected from the group consisting of dipentaerythritol, tridipentaerythritol, pentaerythritol, pentaerythritol polyurethane, phenol, triethylene glycol, resorcinol, inositol, sorbitol, dextrin, and starch.

4. The article of manufacture of claim 1 wherein the blowing agent is selected from the group consisting of urea, butyl urea, benzene sulfonyl-hydrazide, melamine, chloroparaffin, guanidine, glycine, and secondary carbonifics.

5. The article of manufacture of claim 4 wherein the secondary carbonifics include chlorine containing material.

6. The article of manufacture of claim 5 wherein the chlorine containing material is selected from the group consisting of a chlorinated paraffin, and a mixture of a chlorinated paraffin containing about 70%, by weight, of chlorine and a chlorinated paraffin containing about 40% by weight, of chlorine, with a weight ratio of 70% chlorinated paraffin to 40% chlorinated paraffin is about 2:1.

7. The article of manufacture of claim 1 wherein the cementitious inorganic binder includes calcium aluminate cement and silica flour.

8. The article of manufacture of claim 1 wherein the ceramic is selected from the group consisting of ceramic spheres, and silica spheres.

9. The article of manufacture of claim 8 wherein the spheres are in a range of 10 to 500 micron in diameter.

10. The article of manufacture of claim 1 wherein the adhesive binder is a resin.

11. The article of manufacture of claim 10 wherein the resin is selected from the group of styrenic, olefinic, acrylic, cellulosic, polyester, phenolic, rosin, shellfish resin, polyamide, an aliphatic adhesive binding compound, and an aromatic organic adhesive binding compound.

12. The article of manufacture of claim 10 wherein the resin is a thermoset resin.

13. The article of manufacture of claim 10 wherein the resin is a curable resin.

14. The article of manufacture of claim 10 wherein the resin is a thermoplastic.

15. The article of manufacture of claim 1 wherein the cloth fabric is selected from the group of woven glass rovings, woven yarns, veils, cloths, surfacing mattes, non-woven fabric, woven fabrics, knitted fabrics, all glass fabrics, all carbon fabrics, Kevlar fabrics, ceramic fabrics, Nomex fabrics, basalt fabrics, and air texturized fabrics.

16. The article of manufacture of claim 1 wherein the additive powder forms an external fire-retarding layer on the cloth fabric and the adhesive resin forms a reinforced layer on the cloth fabric.

17. The article of manufacture of claim 1 wherein the additive powder is in a form of an aqueous slurry applied to the cloth fabric.

18. The article of manufacture of claim 1 wherein the additive powder is in a form of an aqueous slurry applied to the cloth fabric by dipping.

19. The article of manufacture of claim 1 wherein the additive powder is in a form of an aqueous slurry applied to the cloth fabric by roll coating.

20. The article of manufacture of claim 1 wherein the additive powder is in a form of an aqueous slurry applied the cloth fabric by a knife-over fabric coater.
